(19) United States
(12) Patent Application Publication
(10) Pub. No.: US 2015/0121182 A1
(43) Pub. Date: Apr. 30, 2015

(54) METHOD AND SERVER FOR PROCESSING INFORMATION

(71) Applicant: Xiaomi Inc., Beijing (CN)

(72) Inventors: Fei Xiangli, Beijing (CN); Bo Wang, Beijing (CN); Li Liu, Beijing (CN); Chunlin Ma, Beijing (CN); Jiechi Ma, Beijing (CN); Jie Xiang, Beijing (CN); Jie Li, Beijing (CN)

(21) Appl. No.: 14/458,268

(22) Filed: Aug. 13, 2014

Related U.S. Application Data
(63) Continuation of application No. PCT/CN2014/077501, filed on May 14, 2014.

(30) Foreign Application Priority Data
Oct. 30, 2013 (CN) 201310528373.1

(51) Int. Cl. G06F 17/24

(52) U.S. Cl. CPC G06F 17/248
USPC 715/202

(57) ABSTRACT

A method for processing information comprises: receiving an information presenting request from a terminal device, the information presenting request comprising at least specified information and a target server identifier for identifying a target server for presenting the specified information; processing the specified information to obtain rich text format (RTF) information corresponding to the specified information; and sending a RTF information presenting request to the target server according to the target server identifier, the RTF information presenting request comprising at least the RTF information. In the present invention, the specified information is processed by a processing server to obtain the RTF information corresponding to the specified information, thus phenomenas such as system crash or halt caused by the terminal device processing the specified information are avoided, and resources of the terminal device are saved.

### CROSS REFERENCE TO RELATED APPLICATION

This application is a Continuation of International Application PCT/CN2014/077501, with an international filing date of May 14, 2014, which claims priority to Chinese Patent Application No. 201310528373.1, filed on Oct. 30, 2013, the entire contents of which are incorporated herein by reference.

### TECHNICAL FIELD

The present disclosure relates to the field of network technology, and more particularly, to a method and a server for processing information.

### BACKGROUND

With the development of network technology and the popularization of information presenting platforms, a user may present different types of information such as text information, pictures or audio files or the like on the information presenting platforms. With increasing user needs, more and more users wish to convert simple text information into rich text format (RTF) information to be presented, for example, to convert text information input by the user into a picture to be presented.

A specific process for presenting the RTF information includes: a terminal device converting the text information input by the user into RTF information and uploading the RTF information to a server associated with the information presenting platform, and then the server presenting the RTF information on the information presenting platform.

However, when the text information is converted into the RTF information, a lot of resources of the terminal device are occupied, phenomenas such as system crash or halt may easily occur, which influences the normal operation of the terminal device. Moreover, since the RTF information is generally large in size, too much data traffic is required when the terminal device uploads the RTF information to the server.

### SUMMARY

Accordingly, the present disclosure provides a method and a server for processing information.

According to a first aspect of embodiments of the present disclosure, there is provided a method for processing information, including: receiving an information presenting request from a terminal device, the information presenting request comprising at least specified information and a target server identifier for identifying a target server for presenting the specified information; processing the specified information to obtain rich text format (RTF) information corresponding to the specified information; and sending a RTF information presenting request to the target server according to the target server identifier, the RTF information presenting request comprising at least the RTF information.

According to a second aspect of the embodiments of the present disclosure, there is provided a server for presenting information, including: a processor; a memory for storing instructions executable by the processor, wherein the processor is configured to execute instructions for: receiving an information presenting request from a terminal device, the information presenting request comprising at least specified information and a target server identifier for identifying a target server for presenting the specified information; processing the specified information to obtain rich text format (RTF) information corresponding to the specified information; and sending a RTF information presenting request to the target server according to the target server identifier, the RTF information presenting request comprising at least the RTF information.

According to a third aspect of the embodiments of the present disclosure, there is provided a non-transitory readable storage medium having stored therein instructions that, when executed by a processor in a server, for performing a method for processing information, the method comprising: receiving an information presenting request from a terminal device, the information presenting request comprising at least specified information and a target server identifier for identifying a target server for presenting the specified information; processing the specified information to obtain rich text format (RTF) information corresponding to the specified information; and sending a RTF information presenting request to the target server according to the target server identifier, the RTF information presenting request comprising at least the RTF information.

It is to be understood that both the foregoing general description and the following detailed description are exemplary and explanatory only and are not restrictive of the present invention.

The technical solutions provided by the embodiments of the present disclosure may include advantageous effects as below.

In the method and the server provided by the embodiments of the present invention, the specified information is processed to obtain the RTF information corresponding to the specified information, thus phenomenas such as system crash or halt caused by the terminal device processing the specified information can be avoided, and the system resource of the terminal device can be saved. Since the terminal device sends the specified information to a processing server instead of the RTF information to the processing server, data traffic between the terminal device and the processing server is reduced.

It is to be understood that both the foregoing general description and the following detailed description are exemplary only and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

In order to more clearly explain the technical solutions in the present disclosure, a simple introduction to the drawings required for describing the embodiments will be given below. Obviously, the drawings described below only illustrate some embodiments of the present disclosure, and for those skilled in the art, other drawings may be obtained based on these drawings without inventive labor. The accompanying drawings described herein are included to provide a further understanding of the present disclosure, constitute a part of this application, and are not restrictive of the present disclosure. In the drawings:

FIG. 1 is a flow chart illustrating a method for processing information, according to an illustrative embodiment of the present disclosure;

FIG. 2 is a flow chart illustrating a method for processing information, according to an illustrative embodiment of the present disclosure;

FIG. 3 is a block diagram illustrating an apparatus for processing information, according to an illustrative embodiment of the present disclosure; and

FIG. 4 is a block diagram illustrating a server, according to an illustrative embodiment of the present disclosure.

The apparent embodiments of the present disclosure are illustrated by the above-mentioned drawings, and detailed descriptions will be given hereinafter. These drawings and literal descriptions do not intend to limit the scope of concept of the present disclosure in any manner, but to explain the concept of the present disclosure for those skilled in the art by referring to exemplary embodiments.

### DETAILED DESCRIPTION

In order to make purposes, technical solutions and advantages of the present disclosure more clear, hereinafter, the present disclosure will be further described in detail in conjunction with embodiments and the drawings. Herein, illustrative embodiments and their explanations of the present disclosure serve to explain the present disclosure, but do not limit the present disclosure.

The embodiments of the present disclosure provide a method, a server and an apparatus for presenting information, and the present disclosure is explained in detail below in combination with the drawings.

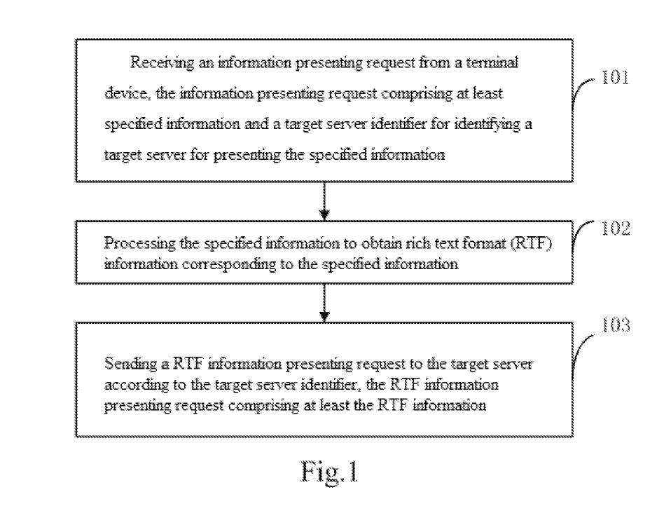

In one embodiment, FIG. 1 is an illustrative flow chart of a method for presenting information. Referring to FIG. 1, the method includes the following steps.

In Step 101, an information presenting request from a terminal device is received, the information presenting request carries at least a target server identifier and specified information. The target server identifier is used to identify a target server for presenting the specified information. The method of the present embodiment is implemented in a processing server communicatively coupled to a plurality of target servers.

In Step 102, the specified information is processed to obtain RTF information corresponding to the specified information.

In Step 103, a RTF information presenting request is sent to the target server, wherein the RTF information presenting request carries at least the RTF information, such that the target server receives the RTF information presenting request and presents the RTF information in response to the RTF information presenting request.

In the method provided by the present embodiment, the specified information is processed by the processing server to obtain the RTF information of the specified information, thus phenomenas such as system crash or halt caused by the terminal device processing the specified information can be avoided, and the system resource of the terminal device can be saved. Moreover, since the terminal device sends the specified information to the processing server instead of the RTF information to the processing server, data traffics between the terminal device and the processing server is reduced.

In some cases, Step 102 specifically includes filling the specified information into a preset template to obtain the RTF information.

The preset template to be filled by the specified information may have different types of RTF formats, which is pre-selected from a plurality of templates. The plurality of templates may include a picture template and an audio template. Accordingly, the step of filling the specified information into the preset template to obtain the RTF information includes: filling the specified information into the picture template to obtain a specified page corresponding to the specified information, and converting the specified page into a picture to obtain the RTF information; or filling the specified information into the audio template, to obtain the RTF information in audio format.

The information presenting request may further carry a user account, and the method further includes: searching in an account database storing relationships between user accounts and target server accounts to determine whether the user account has a corresponding target server account; and proceeding with the step of processing the specified information if the user account has the corresponding target server account.

In some case, before the searching step, the method further includes: receiving a binding request from the terminal device, the binding request carrying the user account of the terminal device and the target server account and a password input by a user; and establishing a relationship between the user account and the target server account.

In some exemplary embodiments, the RTF information includes at least one of a static picture, a dynamic picture, or an audio file.

Moreover, in some exemplary embodiments, the target server is an instant messaging server or an information presenting server.

All of the above alternative technical solutions may be combined in any form to form alternative embodiments of the present invention, which are not described repeatedly.

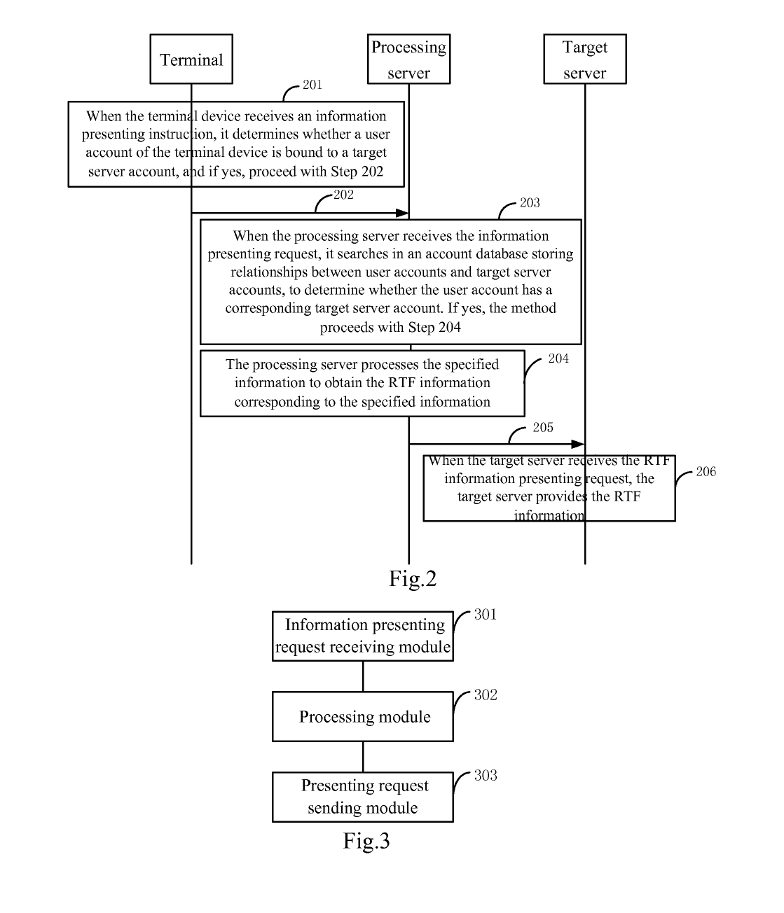

In one embodiment, FIG. 2 is an illustrative flow chart of a method for processing information, which is implemented by a processing server communicatively coupled to and interacts with a terminal device and a target server. Referring to FIG. 2, the method includes the following steps.

In Step 201, when the terminal device receives an information presenting instruction, it determines whether a user account of the terminal device is bound to a target server account, and if yes, proceed with Step 202; and if not, Step 202 may not be performed.

In some cases, the target server account refers to an account registered on the target server, while the target server is used to present the RTF information. The target server may be an instant messaging server or an information presenting server such as a Weibo (a China-based microblogging service) server, an online disk server or a Wechat (a mobile text and voice messaging communication service popular in China) server. Alternatively, the target server may also be implemented as a functional module in the instant messaging server or the information presenting server, which is not limited in the present disclosure.

The present embodiment is applied in a situation in which the RTF information corresponding to the specified information is presented by an instant messaging software or on an information presenting platform. In the present embodiment, the terminal device may provide sharing options such as “Share to Weibo”, “Share to Online disk” or the like for a user to trigger the information presenting instruction. When the terminal device detects the user's click operation to the “Share to Weibo”, the information presenting instruction is determined to be received. Then it is further determined whether the user account of the terminal device is bound to the target server account, i.e., whether the user account of the terminal device is bound to a Weibo account. In addition, the information presenting instruction may also be triggered by a request for modifying a personalized signature, a request for releasing the latest status on a personal homepage and the like, which is not limited in the present embodiment.

In the present embodiment, by performing Step 201, the terminal device can determine whether it is bound with the target server account so as to determine whether the processing server is required to provide the terminal device with the service for converting the specified information to the corresponding RTF information in an information presenting process.

In the present embodiment, when the specified information is presented, in order to have the target server present the specified information by using an identity of the target server account, it is to be determined whether the user account is bound to the target server account. The terminal device may mark a bound identifier for the user account when the processing server binds the target server account to the user account. Correspondingly, Step 201 further includes: determining whether the user account of the terminal device has the bound identifier when the terminal device receives the information presenting instruction. If yes, proceed with Step 202, and if not, Step 202 may not be performed.

It should be noted that the present embodiment is illustrated with the example in consideration of whether the user account of the terminal device is bound to the target server account. However, in some cases, Step 202 may be directly performed without pre-determining whether the user account of the terminal device is bound to the target server account. The processing server may determine whether the user account of the terminal device is bound to the target server account in a subsequent step, or the target server may directly present the RTF information corresponding to the specified information by using an identity of a tourist, which is not limited in the present embodiment.

It should be further noted that the present embodiment is illustrated with the example in which no further operation is performed when the user account of the terminal device is not bound to the target server account. However in some case, after Step 201, the method may further include: if it is determined that the user account of the terminal device is not bound to the target server account, the terminal device presenting an user interface of account information to remind the user to input the target server account required to be bound and the associated password; when the terminal device acquires the target server account and the password input by the user, the terminal device sending to the processing server a binding request carrying the target server account and the password input by the user. Further, when a binding success message sent from the processing server is received, the method proceeds with Step 202.

In Step 202, the terminal device sends an information presenting request to the processing server, the information presenting request carries a user account, specified information and a target server identifier. The target server identifier is used to identify a target server for presenting the specified information.

The specified information may be information in text format or picture format or the like. For example, the specified information may be information pre-selected or pre-input by the user before triggering the information presenting instruction, or the specified information may also be information input on an information presenting interface presented by the terminal device after triggering the information presenting instruction, which is not limited in the present embodiment. Moreover, the user account may be an identifier of the terminal device such as a phone number of the terminal device, an apparatus serial number of the terminal device. Alternatively, the user account may also be a user account for logging in the terminal device such as an Apple ID or a Mione (a mobile phone system developed by Xiaomi Inc.) ID.

In the present embodiment, the target server identifier is used to identify the target server for presenting the specified information. For example, the target server identification may be a name of the target server or an address of the target server and the like, which is not limited in the present embodiment.

Correspondingly, the target server identifier carried by the information presenting request varies with the sharing option selected by the user, such that the determined target server is different. For example, when the terminal device detects that the user's click operation is an option of “Share to Weibo”, the terminal device sends the information presenting request carrying the target server identifier “Weibo” to the processing server, then the target server finally determined is the “Weibo” server. When the terminal device detects that the user's click operation is “Share to Wechat”, the terminal device sends the information presenting request carrying the target server identifier “Wechat” to the processing server, then the target server finally determined is the “Wechat” server.

In the present embodiment, different target servers are determined according to different sharing options selected by the user, thereby the specified information in form of the RTF information can be presented on different target servers.

In Step 203, when the processing server receives the information presenting request, it searches in an account database storing relationships between user accounts and target server accounts, to determine whether the user account has a corresponding target server account. If yes, the method proceeds with Step 204; and if not, Step 204 may not be performed.

In the present embodiment, in order to present the RTF information corresponding to the specified information, the RTF information is required to be generated. The processing server is used to process the specified information to obtain the RTF information of the specified information. Moreover, in order to make the target server present the RTF information by using the identity of the target server account, the processing server may determine whether the user account has the corresponding target server account before processing the specified information.

Different from Step 201, Step 203 is used to determine whether the user account has the corresponding target server account and to acquire the target server account corresponding to the user account if the user account has the corresponding target server account, thereby to present the RTF information by the target server using the target server account in a subsequent step.

In some case, the processing server may automatically assign an target server account to each user account according to the target server accounts reserved for the processing server by the target server, and establish a relationship between the user account and the assigned target server account. Alternatively, when the processing server receives the binding request from the terminal device, the processing server may establish a relationship between the user account of the terminal device and the target server account required to be bound therewith. Meanwhile, the target server account and the password required to be bound may be authorized by the target server.

Correspondingly, prior to Step 203, the method may further include: the processing server receiving the binding request that carries the user account of the terminal device and the target server account and the password input by the user of the terminal device, and sending the target server account and the password to the target server; upon receiving the target server account and the password, the target server authorizing the target server account and the password; when the authentication is passed, the target server sending an authentication pass message to the processing server; and the processing server establishing the relationship between the user account and the target server account while receiving the authentication pass message.

In some examples, the binding request may be triggered while the user clicks a binding option provided by the terminal device, or may also be automatically triggered when the terminal device receives the information presenting instruction and determines that the user account doesn't have the bound target server account, which is not limited in the present embodiment.

In the present embodiment, the processing server establishes the corresponding relationship between the user account and the target server account upon receiving the binding request from the terminal device. Then when the processing server receives the information presenting request from the terminal device, the processing server may determine the target server account corresponding to the user account according to the established relationship, so that the target server finally can present the RTF information corresponding to the specified information by using the identity of the target server account.

Furthermore, in the present embodiment, the corresponding relationship may also be established by the terminal device. When the terminal device sends the information presenting request to the processing server, it also sends the target server account corresponding to the user account with the information presenting request, so that the target server finally can also present the RTF information corresponding to the specified information by using the identity of the target server account. The present embodiment does not limit how and whether the corresponding relationship is established by the terminal device or the processing server.

It should be noted that the present embodiment is illustrated with the example in which no further operation is performed when it is determined that the user account has no corresponding target server account. However, in some cases, when it is determined that the user account has no corresponding target server account, the processing server may also send an account processing failure message to the terminal device, so that the terminal device displays the input interface of the account information, and acquires again the target server account and the password required to be bound by the user, which is not limited in the present embodiment.

In Step 204, the processing server processes the specified information to obtain the RTF information corresponding to the specified information.

In the present embodiment, a preset template of the RTF information may be determined. The specified information is processed according to the preset template. Accordingly, Step 204 includes: the processing server filling the specified information into the preset template to obtain the RTF information.

For example, the RTF information includes at least one of a static picture, a dynamic picture, or an audio file generated from the specified information, while different types of preset templates may correspond to different types of RTF information. Then Step 204 may include one of the following steps.

(1) The processing server fills the specified information into a preset picture template to obtain a specified page corresponding to the specified information, and converts the specified page into a picture to obtain the RTF information.

For example, the preset picture template may be a HTML (Hyper Text Markup Language) template. Then the aforesaid Step (1) further includes the processing server filling the specified information into the HTML template to obtain a HTML page, and converting the HTML page into RTF information in picture format.

(2) The processing server fills the specified information into a preset audio template, to obtain the RTF information in audio format.

In the present embodiment, the processing server may covert the specified information into audio information, fill the audio information into the preset audio template to obtain an audio file, and use the audio file as the RTF information corresponding to the specified information.

In the present embodiment, the processing server may send different types of templates to the terminal device. The terminal device presents the different types of templates to the user, and uses a preset template selected by the user as the preset template for filling the specified information in response to the user's selection operation.

For example, the processing server sends templates of music, a static picture, and a dynamic picture to the terminal device. Next the terminal device presents the received templates. When the terminal device detects that the user selects the template of the dynamic picture, the terminal device acquires the preset template of the dynamic picture as the preset template of the specified information, and informs the processing server of such selection. Then the processing server may process the specified information according to the preset template of the dynamic picture to generate the dynamic picture, and use the generated dynamic picture as the RTF information.

Furthermore, the templates may change with subjects such as seasons, holidays, or birthdays. For example, during the Chinese Mid-Autumn Day, a template themed with the Mid-Autumn Day may be set. Alternatively, by determining the user's birthday according to related information of the target server account of the user, a template themed with celebration of the user's birthday is specifically set for the user on the user's birthday.

Different from updating the preset templates by updating a version of the instant messaging software or an information presenting platform software, in the present embodiment, the form of the RTF information may be updated by dynamically updating the preset templates instead of updating the entire software, thus diversified needs of the user can be satisfied, and the user operation is also simplified.

In Step 205, the processing server sends the RTF information presenting request to the target server, wherein the RTF information presenting request carries the RTF information and the target server account.

In the present embodiment, the RTF information presenting request carries the target server account, so that the target server may present the RTF information by using the identity of the target server account.

In some case, the RTF information presenting request may not carry the target server account, and the target server may present the RTF information by using the identity of the tourist.

In Step 206, when the target server receives the RTF information presenting request, the target server provides the RTF information.

Different target servers provide the RTF information in different ways. With respect to the different target servers, Step 206 may use any one of the following ways.

(1) If the target server is the instant messaging server, then when the instant messaging server receives the RTF information presenting request, the RTF information is presented by using the identity of the target server account in a friend circle link corresponding to the instant messaging server, or the RTF information is presented in the personalized signature of the target server account.

Taking the Wechat server as an example, the Wechat server, when receiving the RTF information presenting request, may present the RTF information by using the identity of the target server account in a friend circle of the Wechat software, or present the RTF information in the personalized signature of the target server account.

(2) If the target server is the information presenting server, then when the information presenting server receives the RTF information presenting request, the RTF information is presented by using the identity of the target server account on the information presenting platform corresponding to the information presenting server.

Taking the Weibo server as an example, the Weibo server, when receiving the RTF information presenting request, may present the RTF information on a personal Weibo webpage corresponding to the target server account.

For different types of RTF information, the target server may present the RTF information in different ways. For the RTF information in static picture format, the target server may directly present the static picture, and for the RTF information in dynamic picture format, the target server may present a thumbnail picture of the dynamic picture, and the dynamic picture is presented when the user clicks the thumbnail picture. The present embodiment does not limit a specific way of the RTF information.

In the method provided by the present embodiment, the specified information is processed by the processing server to obtain the RTF information corresponding to the specified information, thus phenomenas such as system crash or halt caused by the terminal device processing the specified information can be avoided, the system resource of the terminal device can be saved. Furthermore, since the terminal device sends the specified information to the processing server instead of sending the RTF information to the processing server, data traffic between the terminal device and the server is reduced. Also, dynamical update of the preset templates may be realized without updating the software, thus diversified needs of the user can be satisfied and the user operation is simplified.

FIG. 3 is an illustrative block diagram of an apparatus for presenting information. Referring to FIG. 3, the apparatus includes an information presenting request receiving module 301, a processing module 302 and a presenting request sending module 303.

The information presenting request receiving module 301 is configured to receive an information presenting request from a terminal device, the information presenting request comprising at least specified information and a target server identifier for identifying a target server for presenting the specified information. The processing module 302 is coupled to the information presenting request receiving module 301, and configured to process the specified information to obtain RTF information corresponding to the specified information. The presenting request sending module 303 is coupled to the processing module 302, and configured to send a RTF information presenting request to the target server according to the target server identifier, the RTF information presenting request comprising at least the RTF information.

In the apparatus provided by the embodiment of the present invention, the specified information is processed to obtain the RTF information corresponding to the specified information, thus phenomenas such as system crash or halt caused by the terminal device processing the specified information can be avoided, and the system resource of the terminal device can be saved. Moreover, since the terminal device sends the specified information instead of the RTF information to the processing server, data traffic between the terminal device and the server is reduced.

The processing module 302 includes a processing unit configured to fill the specified information into a preset template to obtain the RTF information.

The preset template is pre-selected from a plurality of templates comprising a picture template and an audio template. And the processing module 302 includes: a first processing sub-module for filling the specified information in the picture template to obtain a specified page corresponding to the specified information, and converting the specified page into a picture to obtain the RTF information; or a second processing sub-module for filling the specified information in the audio template to obtain the RTF information in audio format.

The information presenting request further carries a user account, and the apparatus further includes: a target account acquiring module configured to search in an account database storing relationships between user accounts and target server accounts to determine whether the user account has a corresponding target server account; an account processing module configured to perform the step of processing the specified information if the user account has the corresponding target server account.

The apparatus for processing information further includes: a binding request receiving module configured to receive a binding request from the terminal device, the binding request carrying the user account of the terminal device and the target server account and a password input by a user; and a corresponding relationship establishing module configured to establish a relationship between the user account and the target server account.

The RTF information includes at least one of a static picture, a dynamic picture, or an audio file.

The target server is an instant messaging server or an information presenting server.

It should be noted that when the apparatus for presenting information according to the above embodiment presents information, the division of the functional modules as above is described only for illustration, and in actual applications, the above functions may be implemented by different modules as needed. That is, the apparatus can be divided into different modules to realize all or a portion of the above-described functions. In addition, the apparatus for presenting information according to the above embodiments belongs to the same inventive concept as that of the method for presenting information, and the specific implementing processes thereof may be found in the embodiments of the method, which are not described repeatedly.

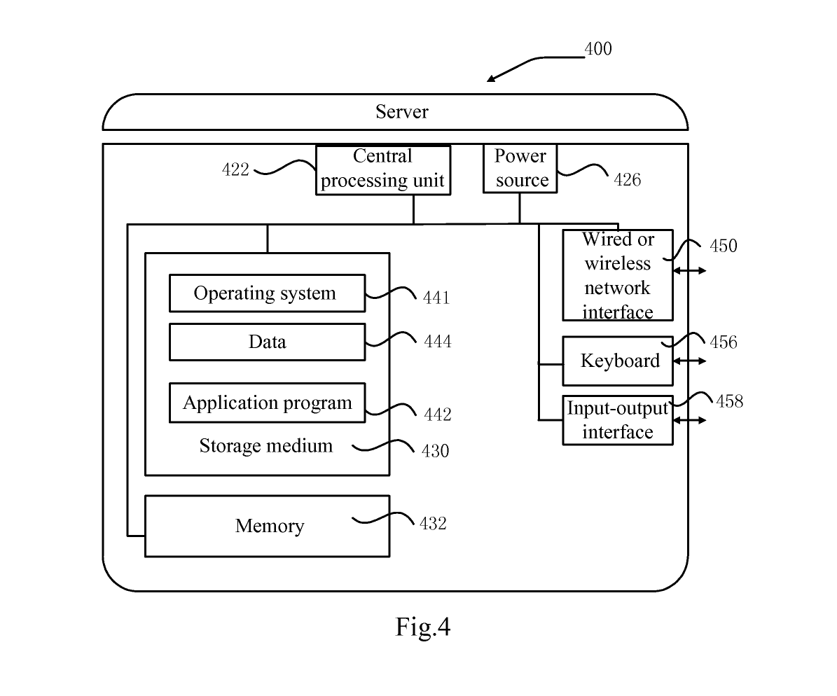

FIG. 4 is an illustrative block diagram of a server. The structure or organization of the server 400 may significantly vary due to different configurations or performances, and may include one or more CPU (central processing units) 422 (e.g., one or more processors) and a memory 432, one or more storage medium 430 storing application programs 442 or data 444 (e.g., one or more mass storage devices). The storage medium 430 and the memory 432 may store the application programs 442 or data 444 temporarily or permanently. The program stored in the storage medium 430 may include one or more modules (not shown in this drawing), and each module may include a series of instructions for operating the server. Furthermore, the CPU 422 may be configured to communicate with the store medium 430 to execute a series of instructions of the storage medium 430 on the server 400.

The server 400 may also include one or more power sources 426, one or more wired or wireless network interfaces 450, one or more input-output interfaces 458, one or more keyboards 456, and/or one or more operating systems 441 such as Windows Server™, Mac OS X™, Unix™, Linux™, FreeBSD™ and the like.

The steps performed by the processing server in the above embodiments may be based on the structure of the server shown in FIG. 4.

In addition, the terminal device according to the present disclosure may typically be various handheld terminal device apparatuses, such as a mobile phone, a personal digital assistant (PDA) and the like. Therefore, the scope of the present disclosure is not limited to a particular type of mobile terminal device.

In addition, the method according to the present disclosure may also be implemented by a computer program executed by a CPU. When executed by the CPU, the computer program performs the above functions defined in the method according to the present disclosure. Specifically, the processor is configured execute instructions for: receiving an information presenting request from a terminal device, the information presenting request comprising at least specified information and a target server identifier for identifying a target server for presenting the specified information; processing the specified information to obtain rich text format (RTF) information corresponding to the specified information; and sending a RTF information presenting request to the target server according to the target server identifier, the RTF information presenting request comprising at least the RTF information.

In addition, the above steps of the method and the units of the system may also be implemented with a controller and a computer-readable storage device which stores computer programs that cause the controller to realize the above steps and functions of the units.

In addition, it should be appreciated that the above mentioned computer-readable storage device (such as storage) may be a volatile memory or a nonvolatile memory, or may include the both. For example, but without limitation, the nonvolatile memory may include a read only memory (ROM), a programmable ROM (PROM), an electrically programmable ROM (EPROM), an electrically erasable programmable ROM (EEPROM), or a flash memory. The volatile memory may include a random access memory (RAM) which may serve as an external cache RAM memory. As an example, but without limitation, the RAM may be of various forms, such as a synchronous RAM (DRAM), a dynamic RAM (DRAM), a synchronous DRAM (SDRAM), a double data rate SDRAM (DDR SDRAM), an enhanced SDRAM (ESDRAM), a synchronous link DRAM (SLDRAM) and a direct Rambus RAM (DRRAM). The storage device according to the disclosed aspects is intended to include but not limited to these and other suitable types of memories.

It should be appreciated by those skilled in the art that, various exemplary logical blocks, modules, circuits, and algorithm steps described in conjunction with the present disclosure may be implemented as electronic hardware, computer software or combination of both. In order to clearly illustrate the interchangeability between the hardware and the software, a general description has been given to various illustrative components, blocks, modules, circuits and functions of steps. Whether such functions will be implemented as software or hardware depends on the particular application and the restriction from the design of the whole system. Those functions may be realized in various means for each of the particular application by those skilled in the art without departing the scope of the present disclosure.

Various illustrative logical blocks, modules and circuits described in conjunction with the present disclosure may be implemented or performed by the following components that are designed to perform the above functions: a general purpose processor, a digital signal processor (DSP), a dedicated integrated circuit (ASIC), a field programmable gate array (FPGA) or other programmable logic devices, discrete gates or transistor logics, discrete hardware components or any combination of these components. The general purpose processor may be a microprocessor. Alternatively, the processor may be any one of a conventional processor, a controller, a microcontroller, or a state machine. The processor may be implemented as combination of computing devices, such as combination of a DSP and a microprocessor, a plurality of microprocessors, one or more microprocessors in conjunction with a DSP core, or any other such configuration.

The method and steps of the algorithm described in conjunction with the present disclosure may be directly contained in hardware, in a software module executed by a processor or in combination of the both. The software module may reside in a RAM memory, a flash memory, a ROM memory, an EPROM memory, an EEPROM memory, a registers, a hard disk, a removable disk, a CD-ROM, or any other storage media known in the art. An exemplary storage medium is coupled to the processor such that the processor can read information from the storage medium or write information thereto. In an alternative embodiment, the storage medium may be integrated with the processor. The processor and the storage medium may reside in an ASIC which may reside in a user terminal device. In an alternative embodiment, the processor and the storage medium may reside in a user terminal device as discrete components.

In one or more exemplary designs, the above functions may be implemented in hardware, software, firmware, or any combination thereof. If implemented in software, the above functions may be stored in a computer readable medium as one or more instructions or codes, or transmitted through the computer readable medium. The computer readable medium includes computer storage medium and communication medium. The communication media includes any medium that may be used to transmit computer programs from one location to another location. The storage medium may be any available medium that is accessible by a general or special computer. For example, but without limitation, the computer readable medium may include a RAM, a ROM, an EEPROM, a CD-ROM or other CD storage devices, disk storage device or other magnetic storage devices, or any other medium that may be used to carry or store the required program codes in a form of instructions or data structure and may be accessible by a general or special computer or a general or special processor. In addition, any connection may be appropriately called as a computer-readable medium. For example, if a coaxial cable, a fiber optic cable, a twisted pair, a digital subscriber line (DSL) or wireless technologies such as infrared rays, radio and microwave are used to transmit software from a website, a server or other remote source, the above coaxial cable, the fiber optic cable, the twisted pair, the DSL or wireless technologies such as infrared rays, radio and microwave are all within the definition of the medium. As used herein, the disk and the optical disk include a compression disk (CD), a laser disc, an optical disk, a digital versatile disc (DVD), a floppy disks, a blue-ray disk, among which the magnetic disk normally represents data magnetically, and the optical disk represents data optically by utilizing a laser. The combination of the above contents should also be included in the scope of the computer readable medium.

In an exemplary embodiment, there is provided a non-transitory readable storage medium having stored therein instructions that, when executed by a processor in a server, for performing a method for processing information, the method comprising: receiving an information presenting request from a terminal device, the information presenting request comprising at least specified information and a target server identifier for identifying a target server for presenting the specified information; processing the specified information to obtain rich text format (RTF) information corresponding to the specified information; and sending a RTF information presenting request to the target server according to the target server identifier, the RTF information presenting request comprising at least the RTF information.

Although the exemplary embodiments of the present disclosure has been illustrated in the above contents, it should be noted that, various changes and modifications may be made without departing the scope of the present disclosure that is defined by the claims. The functions, steps and/or operations of the method claims according to the described embodiments of the present disclosure, may not necessarily be performed in a particular order. In addition, although elements of the present disclosure may be described or prescribed in a single form, multiple forms may also be devised, unless the single form is explicitly prescribed.

The objects, technical solutions and advantageous effects of the present disclosure have been explained in a further detail with the above specific embodiments. It should be appreciated that, the above are merely specific embodiments of the present disclosure, and not used to limit the scope of the present disclosure. Any alteration, equivalent replacement, modification and the like within the spirit and principle of the present disclosure should be embraced in the protection scope of the present disclosure.

What is claimed is:

1. A method for processing information, comprising:
receiving an information presenting request from a terminal device, the information presenting request comprising at least specified information and a target server identifier for identifying a target server for presenting the specified information;
processing the specified information to obtain rich text format (RTF) information corresponding to the specified information; and
sending a RTF information presenting request to the target server according to the target server identifier, the RTF information presenting request comprising at least the RTF information.

2. The method according to claim 1, wherein processing the specified information to obtain the RTF information corresponding to the specified information comprises:
filling the specified information in a preset template to obtain the RTF information.

3. The method according to claim 2, wherein the preset template is pre-selected from a plurality of templates comprising a picture template and an audio template, and filling the specified information in the preset template to obtain the RTF information comprises:
filling the specified information in the picture template to obtain a specified page corresponding to the specified information, and converting the specified page into a picture to obtain the RTF information; or
filling the specified information in the audio template to obtain the RTF information in audio format.

4. The method according to claim 1, wherein the RTF information presenting request further comprises a user account, and the method further comprises:
searching in an account database storing relationships between user accounts and target server accounts to determine whether the user account has a corresponding target server account; and
proceeding with the step of processing the specified information if the user account has the corresponding target server account.

5. The method according to claim 4, wherein before searching, the method further comprises:
receiving a binding request from the terminal device, the binding request comprising the user account of the terminal device and the target server account and a password input by a user; and
establishing a relationship between the user account and the target server account.

6. The method according to claim 1, wherein the RTF information comprises at least one of a static picture, a dynamic picture, or an audio file.

7. The method according to claim 1, wherein the target server is an instant messaging server or an information presenting server.

8. A server for processing information, wherein the server comprises:
a processor;
a memory for storing instructions executable by the processor,
wherein the processor is configured to execute instructions for:
receiving an information presenting request from a terminal device, the information presenting request comprising at least specified information and a target server identifier for identifying a target server for presenting the specified information;
processing the specified information to obtain rich text format (RTF) information corresponding to the specified information; and
sending a RTF information presenting request to the target server according to the target server identifier, the RTF information presenting request comprising at least the RTF information.

9. The server according to claim 8, wherein processing the specified information to obtain the RTF information corresponding to the specified information comprises:
filling the specified information in a preset template to obtain the RTF information.

10. The server according to claim 9, wherein the preset template is pre-selected from a plurality of templates comprising a picture template and an audio template, and filling the specified information in the preset template to obtain the RTF information comprises:
filling the specified information in the picture template to obtain a specified page corresponding to the specified information, and converting the specified page into a picture to obtain the RTF information; or
filling the specified information in the audio template to obtain the RTF information in audio format.

11. The server according to claim 8, wherein the RTF information presenting request further comprises a user account, and the method further comprises:
searching in an account database storing relationships between user accounts and target server accounts to determine whether the user account has a corresponding target server account; and
proceeding with the step of processing the specified information if the user account has the corresponding target server account.

12. The server according to claim 11, wherein before searching, the method further comprises:
receiving a binding request from the terminal device, the binding request comprising the user account of the terminal device and the target server account and a password input by a user; and
establishing a relationship between the user account and the target server account.

13. The server according to claim 8, wherein the RTF information comprises at least one of a static picture, a dynamic picture, or an audio file.

14. The server according to claim 8, wherein the target server is an instant messaging server or an information presenting server.

15. A non-transitory readable storage medium having stored therein instructions that, when executed by a processor in a server, for performing a method for processing information, the method comprising:
receiving an information presenting request from a terminal device, the information presenting request comprising at least specified information and a target server identifier for identifying a target server for presenting the specified information;
processing the specified information to obtain rich text format (RTF) information corresponding to the specified information; and
sending a RTF information presenting request to the target server according to the target server identifier, the RTF information presenting request comprising at least the RTF information.

16. The storage medium according to claim 15, wherein processing the specified information to obtain the RTF information corresponding to the specified information comprises:
filling the specified information in a preset template to obtain the RTF information.

17. The storage medium according to claim 16, wherein the preset template is pre-selected from a plurality of templates comprising a picture template and an audio template, and filling the specified information in the preset template to obtain the RTF information comprises:
filling the specified information in the picture template to obtain a specified page corresponding to the specified information, and converting the specified page into a picture to obtain the RTF information; or
filling the specified information in the audio template to obtain the RTF information in audio format.

18. The storage medium according to claim 15, wherein the RTF information presenting request further comprises a user account, and the method further comprises:
searching in an account database storing relationships between user accounts and target server accounts to determine whether the user account has a corresponding target server account; and
proceeding with the step of processing the specified information if the user account has the corresponding target server account.

19. The storage medium according to claim 18, wherein before searching, the method further comprises:
receiving a binding request from the terminal device, the binding request comprising the user account of the terminal device and the target server account and a password input by a user; and
establishing a relationship between the user account and the target server account.

20. The storage medium according to claim 15, wherein the RTF information comprises at least one of a static picture, a dynamic picture, or an audio file.
